(19) United States
(12) Patent Application Publication
(10) Pub. No.: US 2005/0282616 A1
(43) Pub. Date: Dec. 22, 2005

(54) Gaming machine

(75) Inventors: Tatsuhiko Tanimura, Tokyo (JP); Hirofumi Sekiguchi, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE Corp.

(21) Appl. No.: 11/142,187

(22) Filed: Jun. 2, 2005

(30) Foreign Application Priority Data
Jun. 4, 2004 (JP) 2004-167697

(51) Int. Cl. G06F 17/00

(52) U.S. Cl. 463/20

(57) ABSTRACT

In the slot machine 1, there are provided a variable display device having a rotation member on an outer periphery of which a plurality of symbols are formed and the LED lamps arranged within the rotation member, a liquid crystal display device arranged in front of the variable display device, the liquid crystal display device having a light transmittable area through which light passes from a rear side thereof, wherein illumination control of the LED lamps is conducted so as to turn on the LED lamps when the display image on the light transmittable area is able to be displayed without superimposition with the display symbol and so as not to turn on the LED lamps when the display image on the light transmittable area is not able to be displayed without superimposition with the display symbol.

### CROSS-REFERENCE TO THE RELATED APPLICATION (S)

This application is based upon and claims a priority from the prior Japanese Patent Application No. 2004-167697 filed on Jun. 4, 2004, the entire contents of which are incorporated herein by reference.

### BACKGROUND OF THE INVENTION

1. Field of the Invention

The present invention relates to a gaming machine with an image display device arranged in front of a variable display device on which symbols are variably displayed.

2. Description of Related Art

Conventionally, it is known a gaming machine in which a display device (front display device) is independently provided at a front side of a variable display device on which symbols are variably displayed. For example, as shown in Unexamined Japanese Publication No. 2001-252394, it is disclosed a gaming machine in which it is provided a rotation reel display device for conducting variable display of symbols and a light transmittable liquid crystal display device or an transparent EL panel as the front display device. In this gaming machine, an illumination device for illumination of the rotation reel display device is arranged in front of the rotation reel display device and light emitted from the illumination device and reflected on the rotation reel device passes through a light transmittable area of the light transmittable liquid crystal display device and reaches to a front side of the light transmittable liquid crystal display, thereby a player can see and recognize the light.

And as shown in Unexamined Japanese Publication No. 6-269535, it is disclosed a gaming machine in which a back light constructed from LEDs (Light Emitting Diode) and the like is arranged within reels and light irradiates reels from the inner side thereof by utilizing the back light.

In the gaming machine disclosed in Unexamined Japanese Publication No. 2001-252394, in order to easily see the symbols on the rotation reel display device, the back light can be arranged within the rotation reel as shown in Unexamined Japanese Publication No. 6-269535 and light can be irradiated on the rotation reel from an inner side thereof by utilizing the back light.

However, when light is irradiated on the rotation reel from the inner side thereof by utilizing the back light, the symbol irradiated by the back light and the image of the front display device are superimposed and displayed on the light transmittable area, therefore there is a problem that the symbol and the image on the light transmittable area are hard to be seen.

Recently, in this kind of the gaming machine, from a point of view that it is required to raise variety and free degree of effect contents, there are many cases that effect is done on the front display device, therefore role of the front display device becomes important more and more. In this kind of the gaming machine, although game effect can be done by utilizing superimposition display conducted by both the rotation reel display device and the front display device, it is desirable that each of the symbol and the image displayed on the light transmittable area can be easily seen, in order to make the effect contents effective.

### SUMMARY OF THE INVENTION

In order to dissolve the above problems, the present invention has been done and has an object to provide a gaming machine having a variable display device for conducting variable display of symbols and an image display device arranged in front of the variable display device, in which the symbol on the variable display device and the image displayed on the image display device can be easily seen.

In order to accomplish the above object, according to one aspect of the present invention, it is provided a gaming machine comprising:

a variable display device having a rotation member on an outer periphery of which a plurality of symbols are formed and an illumination device arranged within the rotation member;

an image display device arranged in front of the variable display device, the image display device having a light transmittable area through which light of the illumination device passes from a rear side thereof; and

an illumination control device for conducting illumination control of the illumination device so as to turn on the illumination device when a display image on the light transmittable area of the image display device is displayed without superimposition with the symbol and so as to turn off the illumination device when the display image on the light transmittable area of the image display device is displayed with superimposition with the symbol.

In the above gaming machine, when the illumination device is turned on, the display image is displayed on the light transmittable area of the image display device so as not to superimpose with the symbol. And when the display image superimposing with the symbol is displayed, the illumination device is turned off.

As mentioned, according to the present invention, it can be provided a gaming machine with the variable display device for conducting the variable display of the symbols and the image display device arranged in front of the variable display device, in which the symbol on the variable display device and the image displayed on the image display device can be easily seen.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view showing whole construction of a slot machine as a gaming machine according to the embodiment of the present invention,

FIG. 2 is a front view showing a lower image display portion of the slot machine shown in FIG. 1,

FIG. 3 is a perspective view showing construction of reels,

FIG. 4 is a perspective view showing one reel shown in FIG. 3,

FIG. 5 is an explanatory view showing an outline construction of a liquid crystal display device when seeing from a rear side of a cabinet,

FIG. 6 is an exploded perspective view showing a part of the liquid crystal display device,

FIG. 7 is a block diagram showing an electrical construction of the slot machine,

FIG. 8 is a block diagram of an image control circuit,

FIG. 9 is a flowchart showing procedures in a main process from a start of a game to a termination of the game,

FIG. 10 is an explanatory view showing the liquid crystal display device on which a display image is displayed without displaying symbols in light transmittable areas,

FIG. 11 is an explanatory view showing the liquid crystal display device on which the display image and the symbols are displayed in the light transmittable areas,

FIG. 12 is a side view of the reel, and

FIG. 13 is a side view of another reel.

### DETAILED DESCRIPTION OF THE PREFERRED EMBODIMENTS

Hereinafter, the embodiment of the present invention will described. Here, the same number is utilized for the same element and repetitious explanation will be omitted.

In the embodiment, explanation will be done concerning with a slot machine 1 as an example in a case that the present invention is adopted for a gaming machine having a variable display device on which symbols are variably displayed.

### First Embodiment

(Whole Construction Of The Slot Machine)

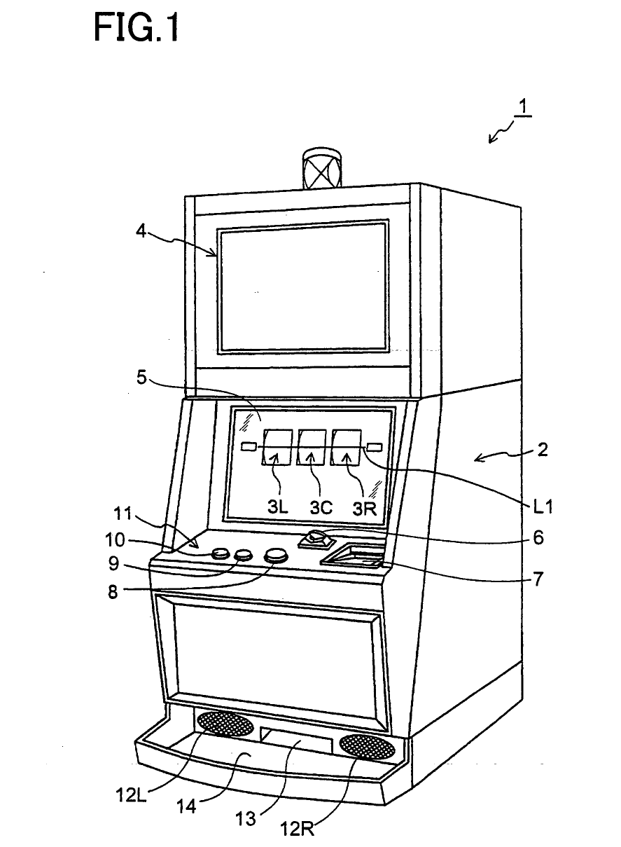

FIG. 1 is a perspective view showing whole construction of the slot machine 1. The slot machine 1 corresponding to the embodiment of the present invention has a variable display device for variably displaying symbols thereon and an image display device arranged in front of the variable display device. In the slot machine 1, it can be done a slot game by utilizing a plurality of symbols displayed on the variable display device.

The slot machine 1 has, according to an order from an upper position, an upper image display portion 4 arranged on a front plane of a cabinet 2 and a lower image display portion 5. The lower image display portion 5 is arranged in a center position of the cabinet 2 in a direction of the upper and lower positions and three mechanical reels 3L, 3C, 3R are rotatably arranged in the cabinet 2 along the horizontal line, so as to correspond to the lower image display portion 5.

Each of the reels 3L, 3C, 3R can be seen and recognized through each of image display areas 21L, 21C, 21R (mentioned later) of the lower image display portion 5 from an external. And as described in detail hereinafter, a symbol column (not shown) having a plural kinds of symbols is described on an outer periphery of each of the reels 3L, 3C, 3R, and the reels 3L, 3C, 3R construct the rotatable variable display device so that each of the symbols is variably displayed. Each of the reels 3L, 3C, 3R rotates at a constant speed (for example, 80 rotations/minute).

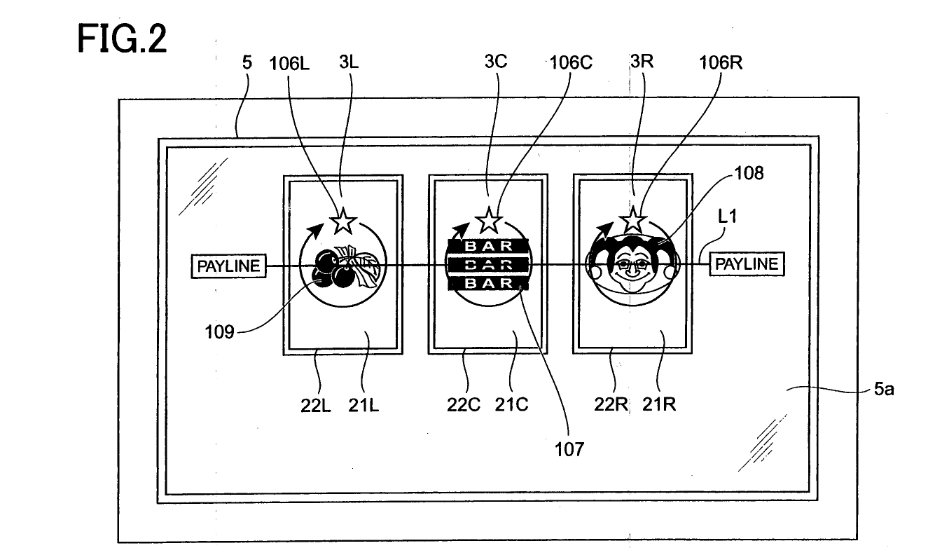

Corresponding to the reels 3L, 3C, 3R, it is formed one pay line L1 horizontally extending in the symbol display areas 21L, 21C, 21R, as shown in FIG. 2. Here, although not shown, in addition to the pay line L1, another pay lines may be independently formed at the upper and the lower positions and further two oblique pay lines may be formed. In a case that a plurality of the pay lines are formed, it is desirable that a number of the pay lines is changed according to a number of coins inserted. In this case, each pay line is activated corresponding to operation of BET switches 9, 10. The activated pay line is called as “active pay line” or “pay line”. Here, in FIG. 2, although it is indicated a state that symbols are stopped only on the pay line L1 in order to easily see, three symbols are generally displayed along the vertical line in each of the symbol display areas 21L, 21C, 21R.

And in the slot machine 1, a control table 11 horizontally extended is formed at a lower side of the lower image display portion 5. And on the control table 11, a coin insertion slot 6, a bill insertion slot 7, a spin switch 8, a 1-BET switch 9 and a maximum BET switch 10 are provided.

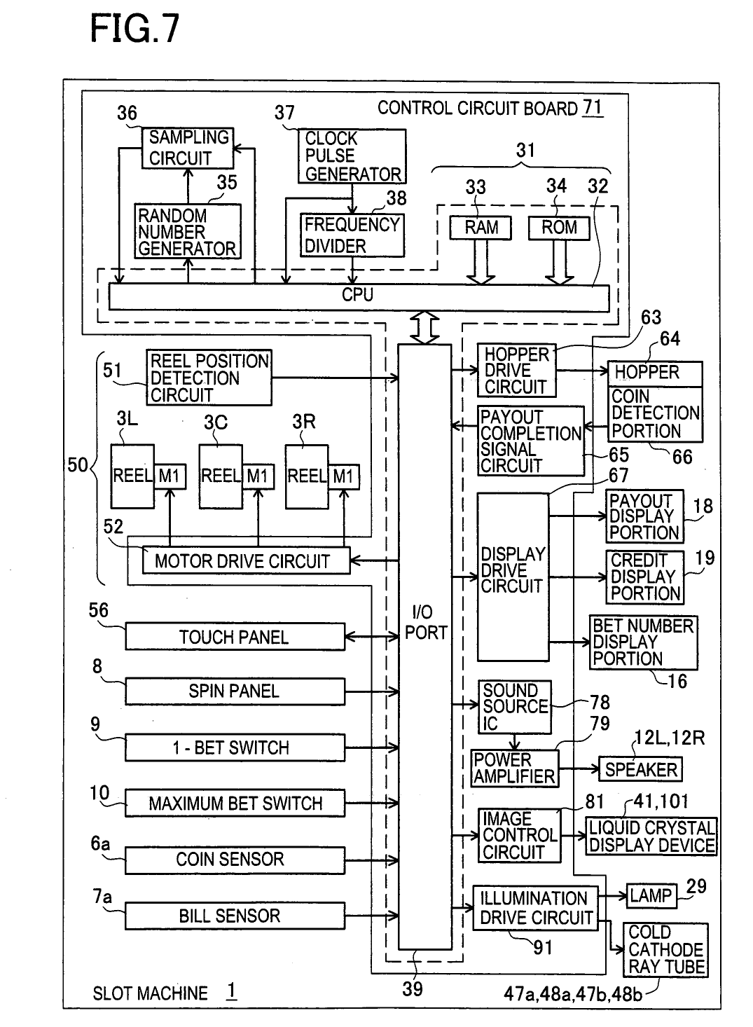

The coin insertion slot 6 is formed in order to insert a coin which the player bets for a game and has a coin sensor 6a (see FIG. 7) for outputting a signal indicating that the coin is inserted. And the bill insertion slot 7 is formed in order that the player inserts a bill thereinto and has a bill sensor 7a (see FIG. 7) for outputting a signal indicating that the player inserts the bill thereinto. And the spin switch 8 is formed in order to start variable display of the symbols within the symbol display areas 21L, 21C, 21R by rotation of the reels 3L, 3C, 3R, that is, in order that the player conducts operation to start the game. The 1-BET switch 9 is formed in order to bet one coin through one time operation thereof. The maximum BET switch 10 is formed in order to bet coins with the maximum number which can be betted in one game through one time operation thereof.

Further, in the slot machine 1, a coin payout opening 13 and a coin tray 14 for receiving the coins paid out from the coin payout opening 13 are formed at a bottom portion of the cabinet 2. Further, speakers 12L and 12R are arranged at both the left and the right positions while remaining the coin payout opening 13 therebetween.

(Explanation Concerning With Each Of The Image Display Portions)

As shown in FIG. 2, the lower image display portion 5 has the image display areas 21L, 21C, 21R, window frame display portions 22L, 22C, 22R and an effect display area 5a. Display contents of the lower image display portion 5 is changed corresponding to the variable display mode and the stop display mode of the reels 3L, 3C, 3R and operation contents of a liquid crystal display device 41 mentioned later. Here, although a BET number display portion 16, a payout display portion 18 and a credit display portion 19 are displayed on the lower image display portion 5 in addition to the above areas, such portions are omitted in FIG. 2.

A liquid crystal display device 101 is arranged on the upper image display portion 4 and display contents thereof are changed corresponding to operation contents thereof.

The symbol display areas 21L, 21C, 21R are formed corresponding to the reels 3L, 3C, 3R, respectively and are areas to display the symbols described on each of the reels 3L, 3C, 3R so that the symbols can be seen and recognized. The symbol display areas 21L, 21C, 21R are made light transmittable so that the symbols described on each of the reels 3L, 3C, 3R can be seen and recognized therethrough.

The window frame display areas 22L, 22C, 22R are formed so as to enclose the symbol display areas 21L, 21C, 21R, respectively, and function as display windows of the symbols described on each of the reels 3L, 3C, 3R.

And in the effect display area 5a, there are displayed effect to increase interest for games and information necessary for the player to beneficially progress the game.

The display contents of the upper image display portion 4 are changed corresponding to operation contents of the liquid crystal display device 101.

(Construction Of The Reel And LED Lamp)

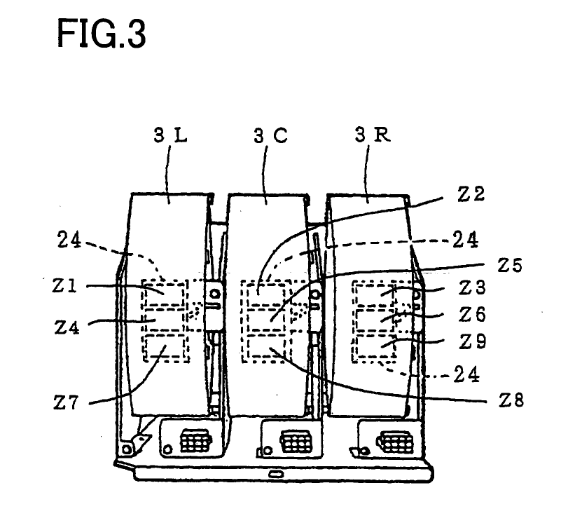

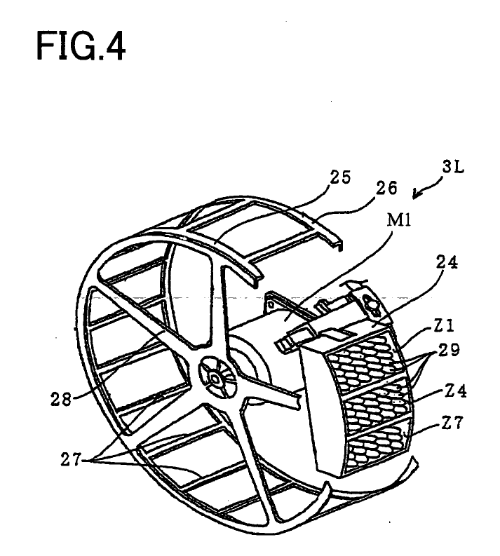

As shown in FIG. 3, each of the reels 3L, 3C, 3R is arranged along the horizontal line and is rotatable. And each of the reels 3L, 3C, 3R has the same construction. As shown in FIG. 4, the reel 3L has two circular frames 25, 26 with the same shapes, the circular frames 25, 26 being arranged while retaining a predetermined distance therebetween. The circular frames 25, 26 are connected by a plurality of connection members 27, thereby the reel 3L concludes to have a cylindrical frame construction. And the reel 3L has force transmission members 28 to transmit driving force of a stepping motor M1 arranged at a center position of the cylindrical frame construction to the circular frames 25, 26. And a light transmittable reel sheet (not shown) is provided on the outer periphery plane of the cylindrical frame construction so as to cover the connection members 27. A plurality of symbols are described on the reel sheet.

And in each of the reels 3L, 3C, 3R, a circuit board 24 for receiving LEDs is arranged at the rear side of the symbols appearing on each of the symbol display areas 21L, 21C, 21R. That is to say, three circuit boards 24 are arranged at the rear side of three symbol columns (symbol number is totally nine) appearing on the symbol display areas 21L, 21C, 21R. This circuit board 24 has three LED receiving portions aligned in the rotation direction of each of the reels 3L, 3C, 3R, and as shown in FIG. 4, a plurality of LED lamps 29 are arranged in each of the LED receiving portions in length and breadth directions. In FIG. 3, the LED receiving portions in each of the reels 3L, 3C, 3R are shown along three horizontal lines. And the LED receiving portions in the upper row are indicated as Z1, Z2, Z3, the LED receiving portions in the center row are indicated as Z4, Z5, Z6, and the LED receiving portions in the lower row are indicated as Z7, Z8, Z9. Further, each of the LED lamps 29 constructs illumination device in the present invention and irradiates white light from the rear side of the reel sheet disposed along the outer periphery plane of each of the reels 3L, 3C, 3R. White light emitted from each of the LED lamps 29 goes through the reel sheet and reaches to the front side thereof and irradiates the liquid crystal display device 41.

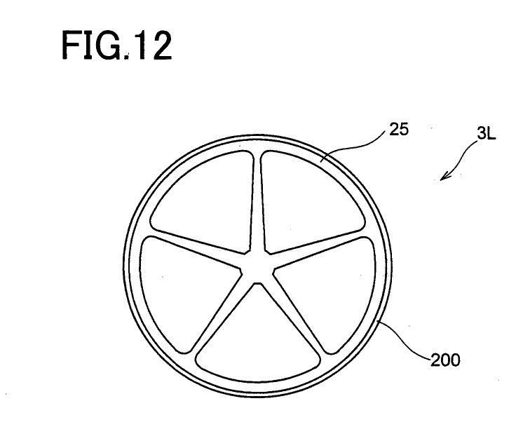

And as shown in FIG. 12, a sheet member 200 with a plurality of protrusions like convex lenses on the reel sheet (not shown) is adhered on the reel 3L.

(Explanation Of Image Display Device)

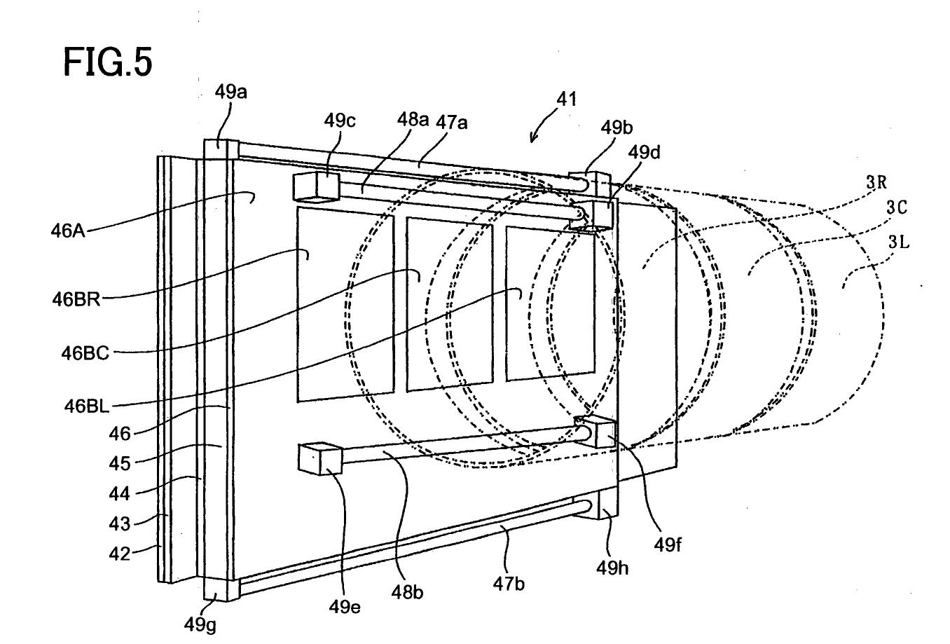

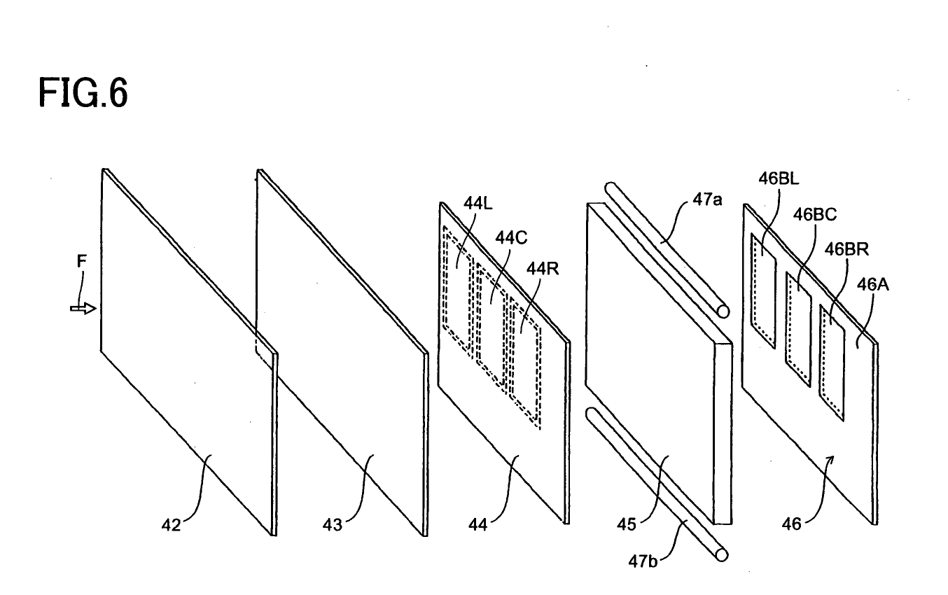

Next, the liquid crystal display device 41 constructing the lower image display portion 5 will be described with reference to FIGS. 5 and 6. FIG. 5 is a perspective view showing the outline construction of the liquid crystal display device 41 when seeing from the rear side of the cabinet 2. And FIG. 6 is an exploded perspective view showing a part of the liquid crystal display device 41.

The liquid crystal display device 41 is arranged at the front side of each of the reels 3L, 3C, 3R while retaining a predetermined distance therebetween so as to cover the reels 3L, 3C, 3R.

The liquid crystal display device 41 has a protect glass 42, a display plate 43, a liquid crystal panel 44 and a light guiding plate 45. Further the liquid crystal display device 41 has a reflection film 46, cold cathode ray tubes 47a, 47b, 48a, 48b as the white light source, lamp holders 49a˜49h and a flexible circuit board (not shown) comprising a table carrier package (TCP) on which a drive IC for driving the liquid crystal panel 44 is installed.

The protect glass 42 and the display plate 43 are made light transmittable. The protect glass 42 is mainly disposed to protect the liquid crystal panel 44. And on the display plate 43 a predetermined image (not shown) is described.

The liquid crystal panel 44 is formed by injecting liquid crystal between one transparent board such as a glass plate and the like on which thin layer transistors are formed and another transparent board opposite thereto. And the liquid crystal panel 44 has light transmittable areas 44L, 44C, 44R, which are able to pass light from the rear side thereof, corresponding to the symbol display areas 21L, 21C, 21R, respectively. This liquid crystal panel 44 becomes white display state (light can pass toward display plane side and such light can be seen from an external) under a condition that voltage is not applied to the liquid crystal panel 44 (liquid crystal panel 44 is not driven), thereby the liquid crystal panel 44 becomes normally white state that the reels 3L, 3C, 3R can be seen and recognized from the front side. By arranging the liquid crystal panel 44 becoming normally white state, even if the liquid crystal injected therein cannot be driven, the symbols described on each of the reels 3L, 3C, 3R can be seen and recognized through the symbol display areas 21L, 21C, 21R and the game can be done while seeing and recognizing variable display and stop display of each of the reels 3L, 3C, 3R.

The light guiding plate 45 has transparency and is arranged at the rear side of the liquid crystal panel 44. The light guiding plate 45 is provided to guide light from the cold cathode ray tubes 47a, 47b to the liquid crystal panel 44.

The reflection film 46 is provided to reflect light introduced into the light guiding plate 45 toward the surface of the light guiding plate 45. The reflection film 46 is formed from a white polyester film or aluminum thin film on which silver layer is vaporized. This reflection film 46 has a reflection area 46A and non-reflection areas 46BL, 46BC, 46BR. The non-reflection areas 46BL, 46BC, 46BR are made of transparent material and formed as light transmittable areas for transmitting incident light from the front surface without reflection. And the non-reflection areas 46BL, 46BC, 46BR form corresponding to the light transmittable-areas 44L, 44C, 44R and are respectively arranged in front of the three symbols aligned along the vertical line, three symbols appearing when rotation of each of the reels 3L, 3C, 3R is stopped. The reflection area 46A reflects incident light from the front surface and functions as the illumination device for illuminating the areas mainly corresponding to the window frame display areas 22L, 22C, 22R and the effect display area 5a within the area of the liquid crystal display panel 44.

The cold cathode ray tubes 47a, 47b are arranged along the upper and the lower ends of the light guiding plate 45 and the both ends of each of the cold cathode ray tubes 47a, 47b are supported through the lamp holders 49a, 49b, 49g, 49h. And the cold cathode ray tubes 47a, 47b emit light introduced into the light guiding plate 45 and function as the illumination device for illuminating the areas mainly corresponding to the window frame display areas 22L, 22C, 22R and the effect display area 5a within the area of the liquid crystal display panel 44.

The cold cathode ray tubes 48a, 48b are arranged at the upper and the lower positions on the rear side of the reflection film 46 so that light is irradiated toward the reels 3L, 3C, 3R from the outside thereof. That is to say, light emitted from the cold cathode ray tubes 48a, 48b is reflected on the surface of the reels 3L, 3C, 3R and introduced into the non-reflection areas 46BL, 46BC, 46BR, and thereafter reaches to the liquid crystal panel 44. Thereby, the cold cathode ray tubes 48a, 48b function as the illumination device for irradiating light to the symbols on the reel sheet arranged on the outer periphery of each of the reels 3L, 3C, 3R from the outside thereof, and irradiate light to the non-reflection areas 46BL, 46BC, 46BR in the reflection film 46. Here, in the embodiment, although it is explained as an example the liquid crystal display device 41 having the cold cathode ray tubes 48a, 48b as the illumination device, it is enough that the illumination device can irradiate light from the outside of the reels 3L, 3C, 3R, thus the illuminations device is not limited to the cold cathode ray tubes 48a, 48b. For example, it may be conceivable that light is irradiated on the outside of the reels 3L, 3C, 3R by utilizing light passing through the light guiding plate 45 from the cold cathode ray tubes 47a, 47b and going toward the rear side thereof. In this case, the cold cathode ray tubes 48a, 48b are not required.

The liquid crystal display device 101 is different from the liquid crystal display device 41 at the following points comparing therewith. That is, the first point is that the liquid crystal display device 101 does not have the non-reflection areas 44L, 44C, 44R: the second point is that touch panel 46 (mentioned later) is not arranged at the front side in the liquid crystal display device 101: and third point is that each of the reels 3L, 3C, 3R is not arranged at the rear side of the liquid crystal display device 101. However, the liquid crystal display device 101 has the same construction as that of the liquid crystal display device 41, except for the above three points.

(Inner Construction Of The Slot Machine)

FIG. 7 is a block diagram showing an electrical construction (inner construction) of the slot machine 1. The slot machine 1 has a control circuit board 71 including a microcomputer 31 and a plurality of elements connected to the control circuit board 71. The control circuit board 71 has the microcomputer 31, a random number generator 35, a sampling circuit 36, a clock pulse generator 37 and a frequency divider 38. Further, the control circuit 71 has a hopper drive circuit 63, a payout completion signal circuit 65, a display drive circuit 67, a sound source IC 78, a power amplifier 79, an image control circuit 81 and an illumination drive circuit 91.

The microcomputer 31 has a CPU (Central Processing Unit) 32, a RAM (Random Access Memory) 33 and a ROM (Read Only Memory) 34. The CPU 32 operates according to programs stored in the ROM 34 and conducts signal input and output between the other elements through an I/O port 39, thereby the CPU 32 conducts whole control of the slot machine 1. The RAM 33 stores data and programs utilized when the CPU 32 operates. And for example, random numbers sampled by the sampling circuit 36 as mentioned later are temporarily stored after the game is started and both code numbers of the reels 3L, 3C, 3R and symbol numbers are stored. In the ROM 34, programs executed by the CPU 32 and permanent data are stored.

The random number generator 35 operates according to the instruction by the CPU 32 and generates random numbers within a predetermined range. And the sampling circuit 36 extracts a voluntary random number among the random numbers generated by the random number generator 35, according to the instruction by the CPU 32, and inputs the extracted random number to the CPU 32. The clock pulse generator 37 produces standard clock pulses to operate the CPU 32, and the frequency divider 38 inputs to the CPU 32 a signal obtained by dividing the standard clock pulses with a predetermined period.

Further, to the control circuit board 71, a reel drive unit 50 is connected. The reel drive unit 50 is provided with a reel position detection circuit 51 for detecting positions of the reels 3L, 3C, 3R, respectively, and a motor drive circuit 52 for inputting drive signals to motors M1, M2, M3, which are utilized to rotate the reels 3L, 3C, 3R. When the drive signals are input to the motors M1, M2, M3 from the motor drive circuit 52, the motors M1, M2, M3 operate, thereby the reels 3L, 3C, 3R are rotated. Further, to the control circuit board 71, the spin switch 8, the 1-BET switch 9, the maximum BET switch 10, the coin sensor 6a and the bill sensor 7a are connected and signals are input to the control circuit board 71 from each of them.

The hopper drive circuit 63 drives the hopper 64 according to control by the CPU 32 and the hopper 64 operates to pay out coins and pays out coins from the payout opening 13. The payout completion signal circuit 65 receives a coin number value data from a coin detection portion 66 connected thereto and outputs a coin payout completion signal to the CPU 32 when the coin number value reaches to a predetermined number value set beforehand. The coin detection portion 66 counts a coin number paid out from the hopper 64 and outputs data of the measured coin number value to the payout completion signal circuit 65. The display drive circuit 67 controls display operation of each display portion (BET number display portion 16, payout display portion 18 and credit display portion 19).

And the sound source IC 78 controls sound signals to output sounds from the speakers 12L, 12R based on the instruction from the CPU 32. The power amplifier 79 receives the sound signals from the sound source IC 78 and amplifies the sound signals input, thereby controls the speakers 12L, 12R so as to output sounds. Thereby, for example, after the game is started, sounds to raise interest for games are output at a convenient time.

Furthermore, to the CPU 32, a touch panel 56 is connected. The touch panel 56 is arranged so as to cover the surface of protect glass 42 positioned at the front side of the lower image display portion 5.

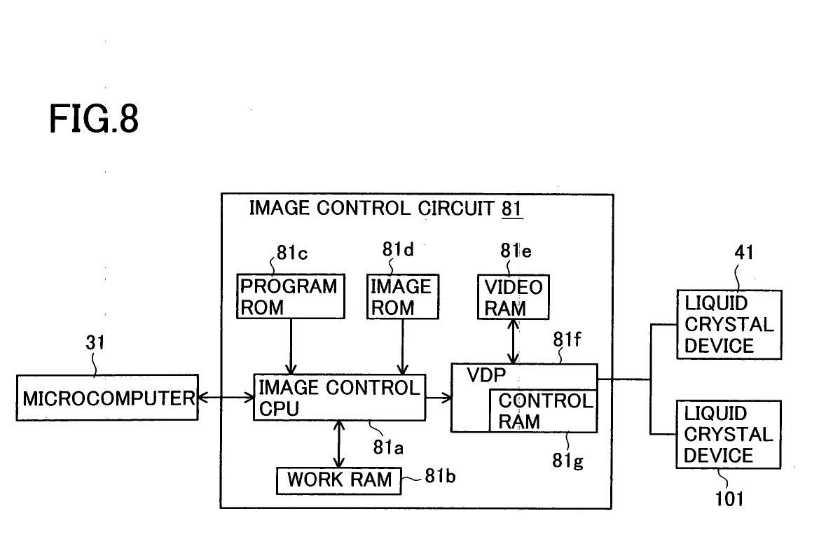

The image control circuit 81 controls image display on each of the liquid crystal display devices 44, 101. The image control circuit 81 has, as shown in FIG. 8, an image control CPU 81a, a work RAM 81b, a program ROM 81c, an image ROM 81d, a video RAM 81e and a VDP (Video Display Processor) 81f. Here, the image control CPU 81a determines images displayed on each of the liquid crystal display devices 44, 101 according to the image control program (concerning with display on the liquid crystal display devices 44, 101) stored beforehand in the program ROM 81c, based on parameters set by the microcomputer 31. The work RAM 81b is constructed as a temporary memory when the image control CPU 81a executes the image control program.

The program ROM 81c stores the image control program and various selection tables. The image ROM 81d stores dot data to form images. The video RAM 81g is constructed as a temporary memory when images are produced by the VDP 81f The VDP 81f has the control RAM 81g and forms images corresponding to display contents of the liquid crystal display devices 44, 101 determined by the image control CPU 81a. Further, the VDP 81f outputs the images formed in the above and controls the liquid crystal display devices 44, 101 so as to display the images.

The illumination drive circuit 91 outputs drive signals according to the instruction by the CPU 32 and controls the LED lamps and the cold cathode ray tubes 48a, 48b so as to turn on and emit light.

(Operation Of The Slot Machine)

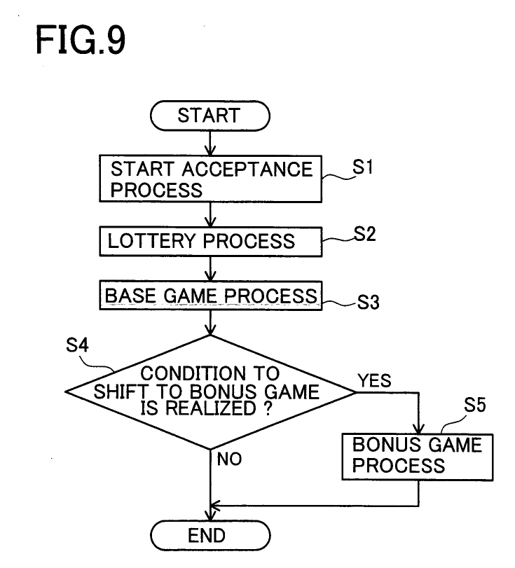

Next, operation of the slot machine 1 constructed according to the above will be described with reference to flowchart shown in FIG. 9. In the slot machine 1 of the embodiment, in addition to a base game done in a base game mode, a game in a special game mode is conducted. And when game mode is in the base game mode, the base game is conducted. On the contrary, when the game mode shifts to the special game mode, a bonus game beneficial for a player is executed.

FIG. 9 is a flowchart showing procedures in a main process executed from start of the game till termination of the game. Here, in FIG. 9, step is abbreviated as “S”.

In the slot machine 1, as shown in FIG. 9, when the main process is started, a start acceptance process is done in S1 according to control by the CPU 32 at the start of the game. Next, a lottery process is executed in S2. Further, in S3, a base game process is done while the game mode is retained to the base game mode and procedure shifts to S4. In S4, the CPU 32 determines whether or not a condition (shift condition) to shift to the bonus game is realized. Here, if the shift condition is realized, procedure shifts to S5, and on the other hand, if the shift condition is not realized, the main process is terminated. In S5, the CPU 32 shifts the game mode to the special game mode and the bonus game is executed. Thereafter, the main process is terminated.

Here, the slot machine 1 has the above construction, thereby the CPU 32 operates as the illumination control device during a series of processes and the illumination instruction signal is input to the illumination drive circuit 91. Thereby, illumination control of the LED lamps 29 is conducted, as a result, both the image (hereinafter, abbreviated as “display image”) displayed on the light transmittable areas 44L, 44C, 44R of the liquid crystal display device 41 and the symbols (hereinafter, abbreviated as “display symbol”) of the reels 3L, 3C, 3R displayed through the light transmittable areas 44L, 44C, 44R can be easily seen and recognized.

At first, in a case that the display image can be displayed based on that the display image does not superimpose with each of symbols described on the reels 3L, 3C, 3R along a direction F (see FIG. 6) along which the symbols are seen and recognized, the CPU 32 outputs the illumination instruction signal to the illumination drive circuit 91 and the LED lamps 29 are turned on. On the other hand, in a case that the display image cannot be displayed based on that the display image superimposes with each of symbols described on the reels 3L, 3C, 3R along the direction F, the CPU 32 controls the LED lamps 29 so as not to turn on (turn off). As mentioned, the illumination control of the LED lamps 29 is conducted according to the above (hereinafter, abbreviated as “first illumination control”).

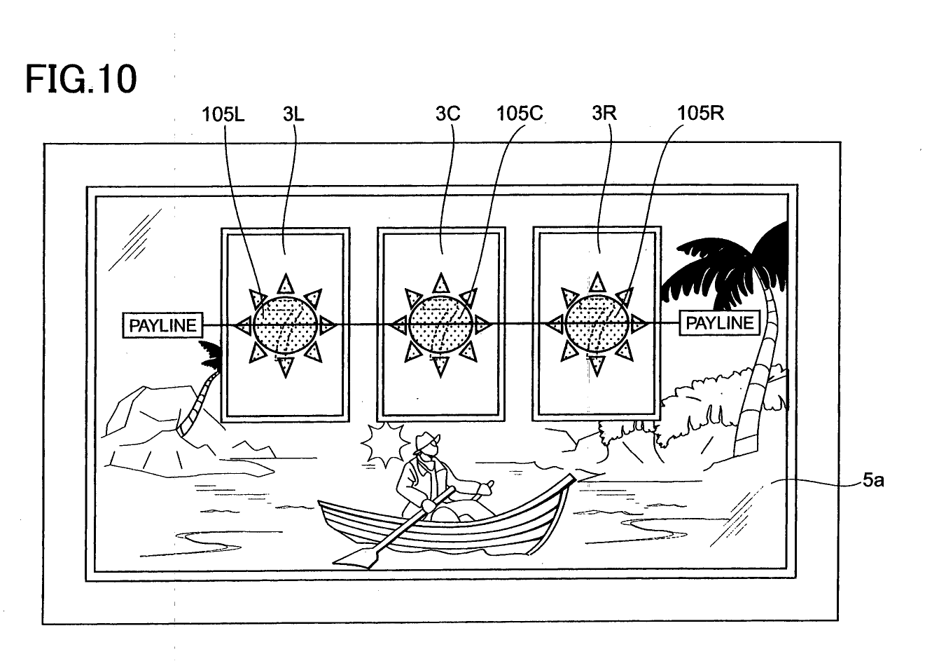

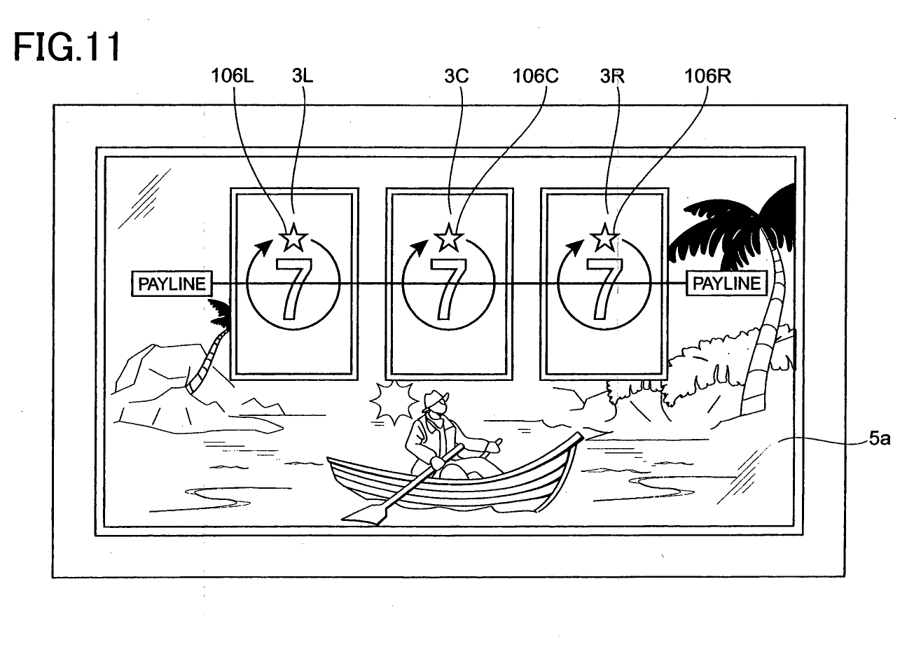

In this case, in the slot machine 1, the effect image of game is mainly displayed on the liquid crystal display device 41. This effect image is displayed by the liquid crystal panel 44. Here, as the above effect image, there will exist the display images displayed on the light transmittable areas 44L, 44C, 44R and the images displayed on the area (for example, effect display area 5a) other than the above light transmittable areas 44L, 44C, 44R. And among the display images displayed on the light transmittable areas 44L, 44C, 44R, there will exist the images (hereinafter, abbreviated as “superimposition display images” corresponding to, for example, the images 105L, 105C, 105R each of which indicates the sun in FIG. 10) which are displayed so as to have portions superimposed with the display symbols of the reels 3L, 3C, 3R along the direction F to see and recognize (that is, the display image cannot be displayed without superimposing with the display symbol) and the images (hereinafter, abbreviates as “non-superimposition display images” corresponding to, for example, the images 106L, 106C, 106R each of which indicates the star moving along the circle) capable of being displayed without superimposing with the display symbol). When the superimposition display image is displayed on each of the light transmittable areas 44L, 44C, 44R, such superimposition display image is superimposed with the display symbol existing at the rear side thereof, therefore it becomes hard to see the display image. However, as shown in FIG. 11, even if the non-superimposition image (here, the image 106L. 106C, 106R) is displayed on each of the light transmittable areas 44L, 44C, 44R, there is no influence for seeing and recognition of the display symbol (here, symbol “7”).

In order to realize the above, concerning with each of the images which are formed by the VDP 81f and displayed, the CPU 32 determines whether the image is the superimposition display image or the non-superimposition display image (this determination is called as “superimposition determination” hereinafter). And if the image is the superimposition display image, the LED lamps 29 are not turned on (turned off), and on the other hand, if the image is the non-superimposition display image, the LED lamps 29 are turned on, thereby illumination control of the LED lamps 29 is conducted. According to the above illumination control of the LED lamps 29, when the superimposition display image is displayed, the LED lamps 29 are not turned on (turned off). Thereby, the display symbol is not seen and recognized by the player because light from the LED lamps 29 dos not pass through the display symbol, thus the display symbol is never seen and recognized with the superimposition image by the player.

On the contrary, when the LED lamps 29 are turned on, although the display image (for example, the symbol “7” shown in FIG. 11) is seen and recognized by the player, the non-superimposition image (the image 106L, 106C, 106R shown in FIG. 11) is displayed when the LED lamps 29 are turned on, therefore there is no influence for seeing and recognition of the display symbol.

As mentioned, in the slot machine 1, since the display image and the display symbol are displayed without superimposition thereof, it can be obtained operation and effect that the display image and the display symbol are easily seen.

And since the sheet member 200 is adhered on the outer periphery of each of the reels 3L, 3C, 3R and the sheet member 200 has a plurality of protrusions like convex lenses, the player sees and recognizes the symbols as three-dimensional images when seeing and recognizing the symbols. Here, as this kind of the sheet member 200, it can be utilized a decoration sheet on which patterns three-dimensionally appearing are changed, this decoration sheet being disclosed, for example, in Unexamined Japanese Publication No. 2003-39583.

On the other hand, although the CPU 32 conducts the superimposition determination and illumination control of the LED lamps 29, in such case, a flag to distinguish the superimposition display image and the non-superimposition display image may be set in the image ROM 81d and the CPU 32 may conduct the superimposition determination corresponding to whether or not the flag set according to the above exist. In addition to the above, illumination control of the LED lamps 29 by the CPU 32 may be done as follows.

That is to say, the CPU 32 outputs the illumination instruction signal to the illumination drive circuit 91 and turns on the LED lamps 29 when the display symbol on each of the reels 3L, 3C, 3R is able to be displayed so that the display symbol does not superimpose with the display image of the liquid crystal display device 44 in the light transmittable areas 44L, 44C, 44R along the direction F to see and recognize. On the contrary, the CPU 32 does not output the illumination instruction signal to the illumination drive circuit 91 and not turn on the LED lamps 29 when the display symbol on each of the reels 3L, 3C, 3R is not able to be displayed based on that the display symbol superimposes with the display image of the liquid crystal display device 44 in the light transmittable areas 44L, 44C, 44R along the direction F to see and recognize. Thereby, illumination control of the LED lamps 29 (hereinafter, abbreviated as “second illumination control”) is done.

In a case of illumination control of the LED lamps 29 (first illumination control) by the superimposition determination mentioned in the above, although the CPU 32 conducts illumination control of the LED lamps 29 while paying attention to the display images of the light transmittable areas 44L, 44C, 44R, the CPU 32 conducts illumination control of the LED lamps 29 while paying attention to the display symbols of the reels 3L, 3C, 3R in the second illumination control. Here, among the display symbols of the reels 3L, 3C, 3R, there exist the symbols (hereinafter, abbreviated as “superimposition display symbol” and for example, as shown in FIG. 2, there are the symbol 107 in which three “BAR”s are aligned along the vertical line and the Joker symbol 108), such symbols being displayed so as to be superimposed with the display images displayed on the light transmittable areas 44C, 44R along the direction F so see and recognize, and the symbols (hereinafter, abbreviated as “non-superimposition display symbol” and for example, as shown in FIG. 2, there is the cherry symbol 109), such symbols being displayed so as not to be superimposed with the display images displayed on the light transmittable areas 44C, 44R along the direction F so see and recognize. In a case that the superimposition display symbol is displayed on the light transmittable area 44L, 44C, 44R, the superimposition display symbol is superimposed with the display image (in a case of FIG. 2, the symbol 106L, 106C, 106R). Therefore, if the LED lamps 29 are turned on, there is fear that both the superimposition display symbol and the display image are hard to be seen and recognized on the basis of the superimposition thereof. However, even if the non-superimposition symbol is displayed, there is no fear mentioned in the above. Therefore, even if illumination control is done by the CPU 32 while paying attention to the symbol on each of the reels 3L, 3C, 3R, the display image on the light transmittable area 44L, 44C, 44R and the display symbol can be distinguished, thus seen and recognized. Thus, it can be obtained operation and effect that the display image and the display symbol are easily seen.

However, even in a case of the superimposition display symbol, there may be a case that such superimposition display symbol becomes the non-superimposition symbol due to the display image displayed on the light transmittable area 44L, 44C, 44R, and on the contrary, even in a case of the non-superimposition symbol (for example, the cherry symbol 109), there may be a case that such non-superimposition symbol becomes the superimposition symbol (for example, the image 105L, 105C, 105R representing the sun) due to the display image displayed on the light transmittable area 44L, 44C, 44R. Further, as for the superimposition display image or the non-superimposition display image, there is a case that such superimposition display image becomes the non-superimposition display image and such non-superimposition display image becomes the superimposition display image due to the relation with the symbol. Considering this point, illumination control of the LED lamps 29 may be done as follows with the first illumination control or the second illumination control, or independent of the first illumination control or the second illumination control.

That is to say, the CPU 32 turns on the LED lamps 29 by outputting the illumination instruction signal to the illumination drive circuit 91 when the symbol of each reel 3L, 3C, 3R should be seen and recognized by the player, and the CPU 32 does not turn on (turn off) the LED lamps 29 by not outputting the illumination instruction signal to the illumination drive circuit 91 when the display image of each light transmittable area 44L, 44C, 44R should be seen and recognized. Thereby, illumination control of the LED lamps 29 (hereinafter, abbreviated as “third illumination control”) is done.

In this case, the CPU 32 conducts illumination control of the LED lamps 29 while distinguishing the case that the display symbol should be seen and recognized with the case that the display image should be seen and recognized. As the former case, for example, it can be raised a case that the game mode is in base game mode, and as the latter case, it can be raised a case that the game mode is in the special game mode. According to this, in the base game mode, it can be realized that the player pays attention to the display symbol rather than the display image, and on the contrary, in the special game mode, it can be realized that the player pays attention to the effect of the game rather than the display symbol. Reversely, if the display symbol should be seen and recognized, the game mode may be the special game mode, and on the other hand, if the display image should be seen and recognized, the game mode may be the base game mode.

In addition to the above, even in any of the base game mode and the special game mode, it can be set the case, in which the symbol should be seen and recognized, to the time that each of the reels 3L, 3C, 3R is stopped. And such case can be set to the time that the reels 3L, 3C, 3R are stopped and the symbols aligned on the pay line become the symbol combination representing a winning symbol combination. On the other hand, for example, as the case that the display image should be seen and recognized, there may be a case that each of the reels 3L, 3C, 3R are rotating.

Further, in the game mode after the start of the game or at each of timings during the game, the CPU 32 determines the case that the display symbol should be seen and recognized or the case that display image should be seen and recognized, and the CPU 32 conducts illumination control of the LED lamps 29 so that, if in the former case, the CPU 32 turns on the LED lamps 29 and if in the latter case, the CPU 32 does not turn on (turn off) the LED lamps 29.

According to the above, illumination control of the LED lamps 29 can be conducted independent of whether the display symbol is the superimposition display symbol or the non-superimposition display symbol and whether the display image is the superimposition display image or the non-superimposition display image. And such illumination control of the LED lamps 29 can be corresponded to the game mode in the slot machine 1 and operation contents during the game. In this slot machine 1, since the LED lamps 29 turn on when the symbol should be seen and recognized by the player, light emitted from the LED lamps 29 and passing through the display symbol can be seen and recognized by the player, therefore the display symbol can be clearly seen and recognized by the player. However, when the display image should be seen recognized by the player, the LED lamps 29 are not turned on (turned off), thus light is never emitted from the LED lamps 29. Therefore, there is no fear that the display symbol and the display image become hard to be seen and recognized due to the superimposition thereof.

As mentioned, illumination control of the LED lamps 29 is done according to which of the display symbol and the display image should be seen and recognized by the player. Accordingly, not only the display symbol and the display image are easily seen but also illumination control of the LED lamps 29 corresponds to operation contents during the game. As a result, effect contents by the liquid crystal display device 41 can be effectively conducted, thus interest for games can be raised.

### Second Embodiment

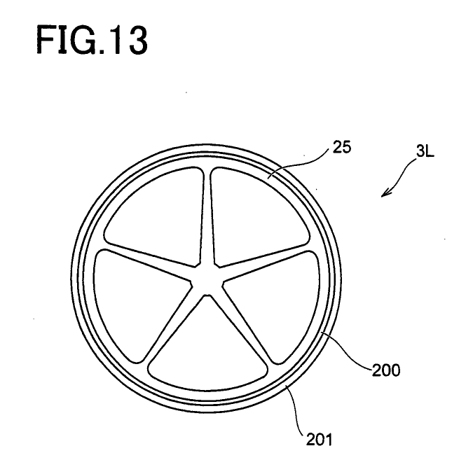

Next, the slot machine 1 according to the second embodiment will described. Comparing with the slot machine 1 of the first embodiment, the slot machine 1 of the second embodiment has different points from the slot machine 1 of the first embodiment at the following two points. That is, the first point is that a mirror plane process portion 201, on which a mirror plane reflection process is done, is formed on the outer periphery on each of the reels 3L, 3C, 3R as shown in FIG. 13. And the second point is that illumination control of both the LED lamps and the cold cathode ray tubes is conducted by the CPU 32. On the mirror plane process portion 201, for example, a mercury membrane is formed, thus light irradiated on the outer periphery of each reel 3L, 3C, 3R is reflected like a mirror.

As mentioned, since each of the reels 3L, 3C, 3R has the mirror plane process portion 201 on the outer periphery thereof, light irradiated from the cold cathode ray tubes 48a, 48b is reflected on the mirror plane process portion 201 and is seen and recognized by the player. Therefore, the outer periphery of each reel 3L, 3C, 3R is seen and recognized by the player as if such periphery is a mirror. In the second embodiment, considering this point, illumination control of the LED lamps 29 and the cold cathode ray tubes 48a, 48b are conducted by the CPU 32 as follows.

That is to say, when the display symbol on each of the reels 3L, 3C, 3R should be seen and recognized by the player, the CPU 32 outputs the illumination instruction signal to the illumination drive circuit 91 and controls the LED lamps 29 so as to be turned on and controls the cold cathode ray tubes 48a, 48b so as not to be turned on (turned off). And when the display image of the light transmittable area 44L, 44C, 44R should be seen and recognized by the player, the CPU 32 controls the LED lamps 29 so as not to be turned on (turned off) and controls the cold cathode ray tubes 48a, 48b so as to be turned on. Thereby, illumination control (hereinafter, abbreviated as “fourth illumination control”) of both the LED lamps 29 and the cold cathode ray tubes 48a, 48b is conducted.

Here, concrete cases when the display symbol should be seen and recognized and when the display image should be seen and recognized are as same as those in the first embodiment, and the timings when the LED lamps 29 are turned on and not turned on are as same as those in the first embodiment. In the second embodiment, in addition to the LED lamps 29, the cold cathode ray tubes 48a, 48b are added, and illumination control of the cold cathode ray tubes 48a, 48b is conducted as follows.

When the display symbol should be seen and recognized, the cold cathode ray tubes 48a, 48b are not turned on (turned off) by control of the CPU 32, thereby the mirror plane reflection does not occur on the mirror plane process portion 201. However, since the LED lamps 29 are turned on, light emitted from the LED lamps 29 and passing through the display symbol is seen and recognized by the player, thus the display symbol is seen and recognized by the player.

On the other hand, when the display image of the light transmittable area 44L, 44C, 44R should be seen and recognized, the cold cathode ray tubes 48a, 48b are turned on while the LED lamps 29 are turned off without turning on. Although operation and effect occurring due to that LED lamps 29 are turned off are as same as those in the first embodiment, light emitted from the cold cathode ray tubes 48a, 48b based on that the cold cathode ray tubes 48a, 48b are turned on is irradiated on the mirror plane process portion 201 and mirror plane reflection occurs by the mirror plane process portion 201. Thereby, the outer periphery plane of the reel 3L, 3C, 3R looks like the mirror for the player, thus the display symbol cannot be seen and recognized.

Namely, if the fourth illumination control is done, when the display symbol should be seen and recognized, the display symbol can be seen and recognized based on that the LED lamps 29 are turned on. On the other hand, when the display image should be seen and recognized, the LED lamps 29 are not turned on. Further, the outer periphery of the reel 3L, 3C, 3R looks like the mirror due to the mirror plane reflection on the mirror plane process portion 201 and the symbol cannot be seen from an external. Thus, the display image can be more clearly seen and recognized than in the first embodiment. Accordingly, there never occurs a case that the display image and the display symbol are superimposed with each other and cannot be seen and recognized on each of the light transmittable areas 44L, 44C, 44R. As a result, operation and effect that the display symbol and display image are more easily seen can be realized. Further, since illumination control of the LED lamps 29 corresponds to operation contents during the game, effect contents by the liquid crystal display device 41 can be effectively conducted, thus interest for games can be raised.

Here, in the above embodiments, although explanation is done according to the slot machine 1 having mechanical reels 3L, 3C, 3R, the present invention can be, of course, adopted to a Japanese pachi-slot machine having mechanical reels 3L, 3C, 3R.

And in the slot machine 1, although the cold cathode ray tubes 47a, 47b, 48a, 48b are utilized, the present invention is not limited to this. Various illumination devices can be adopted to the present invention. And in a case that light emitted from the liquid crystal panel 44 is large enough, the cold cathode ray tubes 47a, 47b to illuminate both the window frame portions 22L, 22C, 22R and the effect display area 5a, and the cold cathode ray tubes 48a, 48b to illuminate the reels 3L, 3C, 3R from outside thereof may be omitted.

Further, although the liquid crystal display device 41 is arranged in the slot machine 1, a transparent EL panel may be utilized instead of the liquid crystal display device 41. Since the transparent EL panel illuminates by itself, light amount of the light source arranged at the rear side of the liquid crystal display device 41 can be reduced by utilizing the transparent EL panel.

And in the slot machine 1, another liquid crystal display device may be arranged in front side of the liquid crystal display device 41 while retaining a transparent acrylic resin plate therebetween and superimposition construction of two liquid crystal display devices (superimposition arrangement construction) along the direction to see and recognize may be adopted. According to the superimposition arrangement construction, images enough expressing far and near feeling and cubic effect can be displayed on the lower image display portion 5.

Here, in the slot machine 1, although three reels are horizontally aligned along a straight line and arranged, the number of reels is not limited to three. For example, the number of reels may be five or nine.

And although the slot machine 1 is the gaming machine in which insertion of coins is required at the start of the game, the present invention can be adopted to a gaming machine in which credit of coins and the like or use of money information stored in a prepaid card is required at the start of the game.

1. A gaming machine comprising:
a variable display device having a rotation member on an outer periphery of which a plurality of symbols are formed and an illumination device arranged within the rotation member;
an image display device arranged in front of the variable display device, the image display device having a light transmittable area through which light of the illumination device passes from a rear side thereof; and
an illumination control device for conducting illumination control of the illumination device so as to turn on the illumination device when a display image on the light transmittable area of the image display device is displayed without superimposition with the symbol and so as to turn off the illumination device when the display image on the light transmittable area of the image display device is displayed with superimposition with the symbol.

2. The gaming machine according to claim 1, wherein the illumination control device conducts the illumination control of the illumination device so as to turn on the illumination device when the symbol on the rotation member is displayed without superimposition with the display image on the light transmittable area of the image display device and so as to turn off the illumination device when the symbol on the rotation member is displayed with superimposition with the display image.

3. The gaming machine according to claim 1, wherein the illumination control device conducts the illumination control of the illumination device so as to turn on the illumination device when the symbol is to be seen and recognized to a player and so as to turn off the illumination device when the display image on the light transmittable area of the image display device is to be seen and recognized to the player.

4. The gaming machine according to claim 1, further comprising:
second illumination device for illuminating the rotation member; and
a mirror plane process portion on the outer periphery of the rotation member, the mirror plane process portion being formed by a mirror plane reflection process;
wherein the illumination control device conducts the illumination control of the illumination device so as to turn on the illumination device arranged within the rotation member and to turn off the second illumination device when the symbol is to be seen and recognized and so as to turn off the illumination device arranged within the rotation member and turn on the second illumination device when the display image on the light transmittable area of the image display device is to be seen and recognized.
